(19) United States
(12) Patent Application Publication
(10) Pub. No.: US 2012/0212973 A1
(43) Pub. Date: Aug. 23, 2012

(54) DISPLAY MODULE AND DISPLAY DEVICE USING THE SAME

(75) Inventors: Kuan-Li Lin, Miao-Li County (TW); Cheng-Yu Cheng, Miao-Li County (TW)

(73) Assignee: CHIMEI INNOLUX CORPORATION, Miao-Li County (TW)

(21) Appl. No.: 13/240,658

(22) Filed: Sep. 22, 2011

(30) Foreign Application Priority Data
Feb. 17, 2011 (TW) 100105319

(51) Int. Cl. F21V 7/04

(52) U.S. Cl. 362/602

(57) ABSTRACT

A display module and a display device using the same are provided. The display module comprises a back plate support, a display panel, the frame and a light source. The display panel is disposed on the back plate support. The frame is disposed adjacent to the back plate support and has a bending portion. The light source is disposed adjacent to the bending portion and connected to the frame.

This application claims the benefit of Taiwan application Serial No. 100105319, filed Feb. 17, 2011, the subject matter of which is incorporated herein by reference.

### BACKGROUND OF THE INVENTION

1. Field of the Invention

The invention relates in general to a display module and a display device using the same, and more particularly to a display module with a frame and a display device using the same.

2. Description of the Related Art

Referring to FIG. 1 (prior art), a cross-sectional view of a portion of a conventional display module is shown. The display module 12 comprises a back plate support 16, a plastic housing 14, a ring frame 18, a light guide plate 20 and a light source 22. The light guide plate 20 is disposed on the back plate support 16. The plastic housing 14 is made from plastics and disposed around the entire peripheral of the light guide plate 20. The light source 22 is disposed adjacent to the light guide plate 20 and engaged on the plastic housing 14. The ring frame 18 is disposed on the plastic housing 14 and encapsulates the peripheral of the plastic housing 14. The back plate support 16 is made from a metal material for transmitting the heat generated by the light source 22. The light source 22 directly contacts the back plate support 16.

In order to carry the light guide plate 20, the light source 22 and other optical elements, the back plate support 16 needs a larger volume or area. The back plate support 16 which is made from metal weighs heavier and incurs higher cost. Thus, the weight and manufacturing cost of the conventional display module 12 cannot be effectively reduced.

### SUMMARY OF THE INVENTION

The invention is directed to a display module and a display device using the same. The heat generated by the display module can be transmitted to the exterior through the frame so as to reduce the weight and manufacturing cost of the display module.

According to an aspect of the present invention, a display module is provided. The display module comprises a back plate support, a display panel, a frame and a light source. The display panel is disposed on the back plate support. The frame is disposed adjacent to the back plate support and has a bending portion. The light source is disposed adjacent to the bending portion and connected to the frame.

According to another aspect of the present invention, a display device is provided. The display device comprises a display module and a casing. The display module comprises a back plate support, a display panel, a frame and a light source. The display panel is disposed on the back plate support. The frame is disposed adjacent to the back plate support and has a bending portion. The light source is disposed adjacent to the bending portion and connected to the frame. The casing encapsulates a portion of the display module.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) shows a cross-sectional view of a portion of a conventional display module;

FIG. 2 shows a 3D diagram of a display device according to an embodiment of the invention;

FIG. 3 shows a 3D diagram of the display module of FIG. 2;

FIG. 4 shows an explosion diagram of the display module of FIG. 3;

FIG. 5 shows a cross-sectional view along the direction 5-5′ of FIG. 3; and

FIG. 6 shows a cross-sectional view along the direction 6-6′ of FIG. 3.

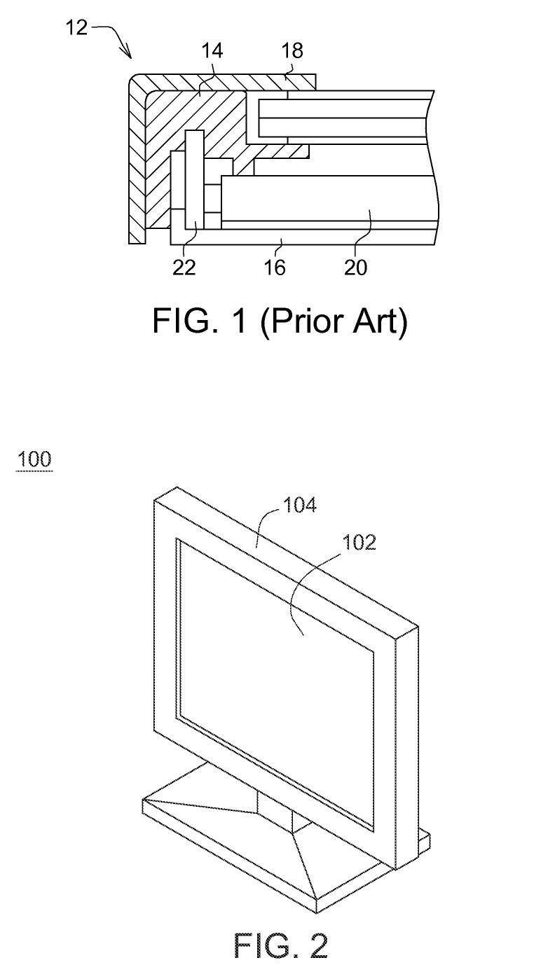

### DETAILED DESCRIPTION OF THE INVENTION

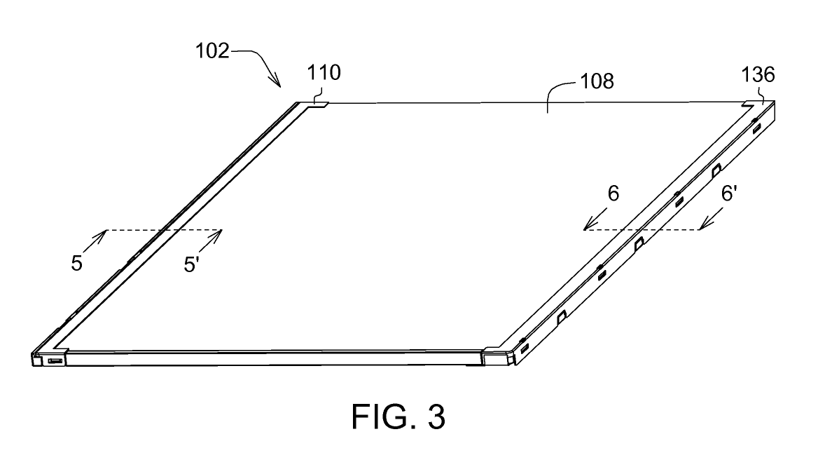

Referring to FIGS. 2 and 3. FIG. 2 shows a 3D diagram of a display device according to an embodiment of the invention. FIG. 3 shows a 3D diagram of the display module of FIG. 2. As indicated in FIG. 2, the display device 100, realized by such as a liquid crystal display device or a display device of other type, comprises a display module 102 and a casing 104. The casing 104 encapsulates a portion of the display module 102 and exposes the display region of the display module 102.

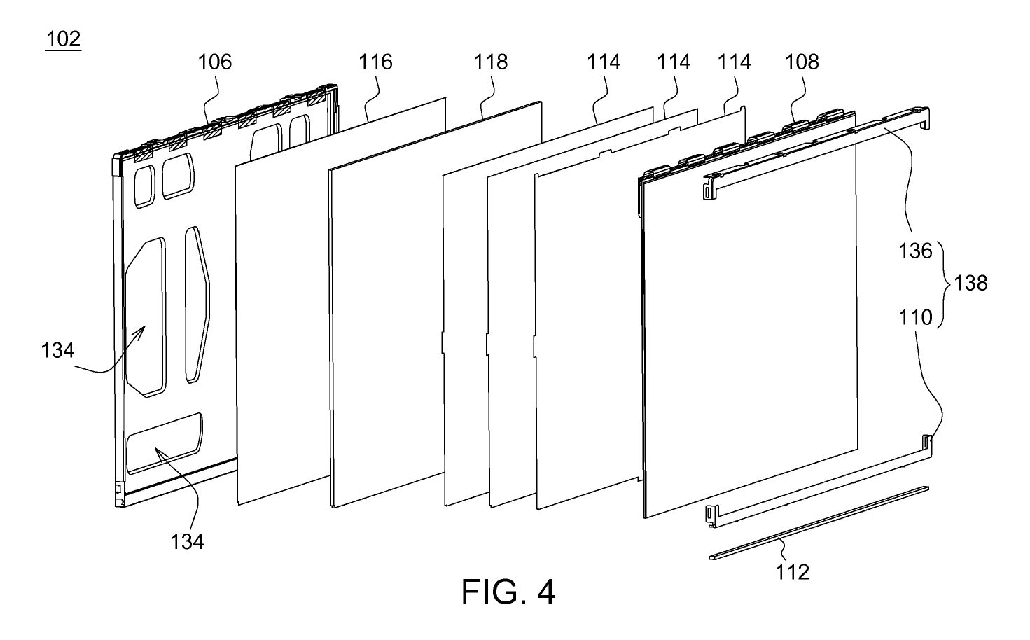

Referring to FIG. 3 and FIG. 4. FIG. 4 shows an explosion diagram of the display module of FIG. 3. The display module 102 comprises a back plate support 106, a display panel 108, a frame 138, at least an optical film 114, a light source 112, a reflector 116 and a light guide plate 118. The optical films 114 can be realized by such as prism sheets or diffusers, and the types of optical films 114 can be the same or different. The light source 112 is disposed adjacent to the light incoming side 118s of the light guide plate 118, so that the light source 112, the reflector 116 and the light guide plate 118 together form a side-type backlight module. The light source 112, realized by such as a light bar or a light source module, comprises at least a light-emitting diode (LED).

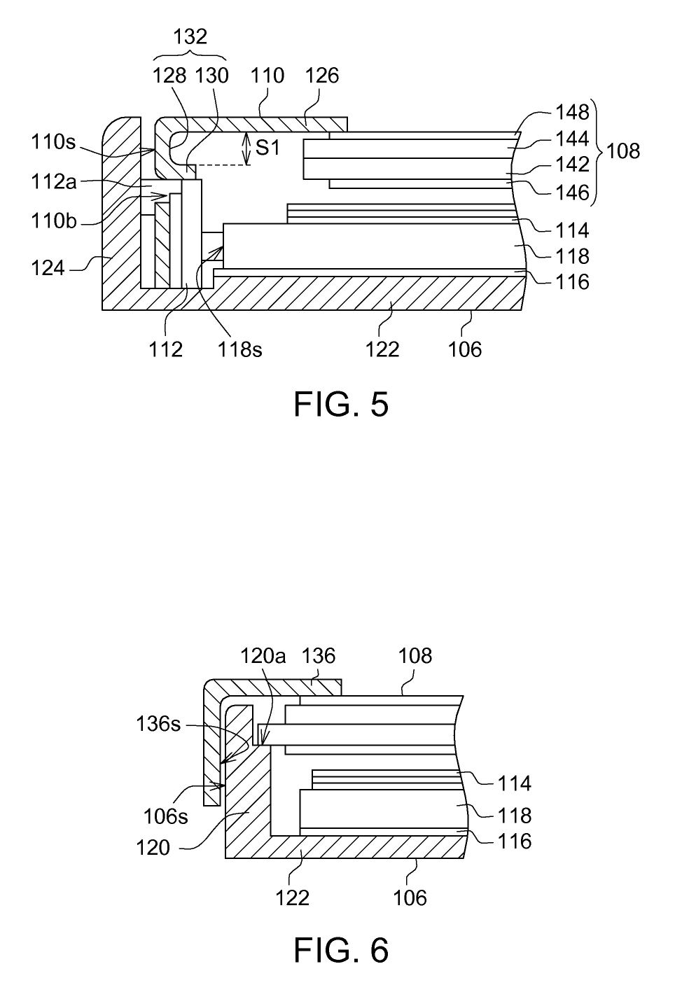

The frame 138 of the present embodiment of the invention comprises two frames 110 and 136 which are separately disposed. In an implementation, the frame 138 can be designed as a single-piece frame. For example, the frames 110 and 136 can be connected by a connection member (not illustrated) to form a single-piece frame, such as a ring frame. Both the frames 110 and 136 and the single-piece frame can be formed by at least one of the stamping process and the bending process. In addition, when the frame 138 is a single-piece frame, at least one side of the frame has the structure as illustrated in FIG. 5 (elaborated below), and the other side has the structure as illustrated in FIG. 6 (elaborated below).

Referring to FIG. 5, a cross-sectional view along the direction 5-5′ of FIG. 3 is shown. The display panel 108 comprises a thin film transistor matrix substrate 142, a color filter substrate 144, a first polarizing film 146 and a second polarizing film 148. The thin film transistor matrix substrate 142 is connected adjacent to the color filter substrate 144. The first polarizing film 146 is disposed on the thin film transistor matrix substrate 142. The second polarizing film 148 is disposed on the color filter substrate 144.

As indicated in FIG. 5, the frame 110 has at least a bending portion 132. The light source 112 is disposed adjacent to the bending portion 132 and connected to the frame 110.

The bending portion of the frame has many implementations, and is exemplified below by one of the implementations. As indicated in FIG. 5, the frame 110 comprises a first portion 126, a connecting portion 128 and a second portion 130. The connecting portion 128 connects the first portion 126 to the second portion 130. The connecting portion 128 and the second portion 130 together form the bending portion 132 of the frame 110. That is, a first bending angle is contained between the bending portion 132 and the first portion 126. Furthermore, a second bending angle can also be contained between the connecting portion 128 and the second portion 130. The first bending angle can be identical to or different from the second bending angle. In an implementation, the first bending angle is substantially identical to the second bending angle. That is, the first portion 126 and the second portion 130 are substantially in parallel.

The light source 112 is disposed adjacent to the second portion 130 of the frame 110, wherein, the light source 112 can directly contact the second portion 130 of the bending portion 132 or can be separated from the second portion 130 by a gap.

According to the embodiment of the invention, the dimension of the bending portion is adjusted to meet the dimension of the light source. For example, the first portion 126 and the second portion 130 are separated by a distance S1, and the distance S1 can be adapted to the height of the light source 112, so that the light source 112 can be disposed adjacent to the bending portion 132. When the light source 112 has a standardized dimension, the dimension of the light source is normally hard to change. However, through the dimension design of the bending portion 132 of the present embodiment of the invention, the bending portion 132 can be easily disposed adjacent to the light source with a standard dimension.

The frame can be a bar-shaped frame or a ring-shaped frame. In the present embodiment of the invention, the frame 110 is exemplified by a bar-shaped frame as indicated in FIG. 3. Compared to the ring frame, the bar-shaped frame 110 requires less material, so that the weight of the frame 110 as well as the weight and manufacturing cost of the display module 102 are reduced.

The frame 110 is made from a material with excellent thermal conductivity so as to quickly transmit the heat generated by the light source 112 to the exterior of the display module 102. Also, the heat generated by the light source 112 of the present embodiment of the invention can be dissipated to the exterior through the frame 110.

The frame 110 can be realized by a metal frame or a thermo-conducting frame made from such as aluminum, magnesium or aluminum magnesium alloy, zinc coated steel, aluminum zinc coated steel, tin plate, stainless steel.

The light source can be connected to the frame by way of engaging or other method. For example, the light source 112 has a first engaging portion 112a, the frame 110 has a second engaging portion 110b, and the light source 112 can be firmly fixed on the frame 110 through the engaging between the first engaging portion 112a and the second engaging portion 110b. Under such circumstances, the first engaging portion 112a is made from a material with excellent thermal conductivity so as to quickly transmit the heat generated by the light source 112 to the exterior of the display module 102. When the first engaging portion 112a is one of a protrusion and an indentation, the second engaging portion 110b is the other of a protrusion and an indentation. In the present embodiment of the invention, the first engaging portion 112a is exemplified by a protrusion, and the second engaging portion 110b is exemplified by an indentation. In other implementations, the first engaging portion 112a or the second engaging portion 110b can also be a dissipation pad.

In other implementations, the bending portion 132 of the frame 110 can press the light source 112 to fix the light source 112. Under such circumstances, the light source 112 and the frame 110 can omit the engaging portion. Or, the light source 112 can be connected to the frame 110 through a thermo-conducting adhering element (not illustrated). Under such circumstances, the light source 112 and the frame 110 can also omit the engaging portion. The aforementioned thermo-conductive adhering element is such as viscose.

The back plate support 106 comprises at least a second lateral portion 124. The frame 110 has an outer lateral surface 110s. The second lateral portion 124 is adjacent to and faces outer lateral surface 110s. In addition, the back plate support 106 further comprises a carrying portion 122 connected to the second lateral portion 124. The reflector 116, the light guide plate 118 and the optical film 114 are all disposed on the carrying portion 122.

In addition, the back plate support 106 can have at least a hollowed portion 134 (illustrated in FIG. 4) so as to reduce the weight and material cost of the back plate support 106.

The display panel can be disposed on the back plate support. Referring to FIG. 6, a cross-sectional view along the direction 6-6′ of FIG. 3 is shown. The back plate support 106 comprises at least a first lateral portion 120. The display panel 108 is disposed on the back plate support 106 such as on the end surface 120a of the first lateral portion 120 of the back plate support 106. The first lateral portion 120 is connected to the carrying portion 122. In addition, the back plate support 106 is made from an insulation material such as plastics or rubber. Furthermore, the back plate support 106 of the present embodiment of the invention can be made from a light material so as to replace conventional metal material which is heavier, hence largely reducing the weight and manufacturing cost of the display module 102.

As indicated in FIG. 6, the frame 136 has an inner lateral surface 136s adjacent to and faces the first lateral portion 120 of the back plate support 106 such as faces the outer lateral surface 106s of the first lateral portion 120. The inner lateral surface 136s of the frame 136 and the outer lateral surface 106s of the back plate support 106 are separated by a gap and do not contact each other directly. Or, the inner lateral surface 136s of the frame 136 and the outer lateral surface 106s of the back plate support 106 directly contact each other.

The display module and the display device using the same disclosed in the above of embodiments of the invention have many features exemplified below:

1). The bar-shaped frame requires less material, so that the weight of the frame as well as the weight and manufacturing cost of the display module are reduced

2). The frame can be made from a material with excellent thermal conductivity so as to quickly transmit the heat generated by the light source to the exterior of the display module.

3). The light source is connected to the frame for transmitting the heat generated by the light source to the exterior of the display module through the frame.

4). The back plate support made from a light material replaces the conventional heavy metal material, hence largely reducing the weight and manufacturing cost of the display module.

While the invention has been described by way of example and in terms of the preferred embodiment (s), it is to be understood that the invention is not limited thereto. On the contrary, it is intended to encapsulate various modifications and similar arrangements and procedures, and the scope of the appended claims therefore should be accorded the broadest interpretation so as to encompass all such modifications and similar arrangements and procedures.

What is claimed is:

1. A display module, comprising:
a back plate support;
a display panel disposed on the back plate support;
a frame disposed adjacent to the back plate support and having a bending portion; and
a light source disposed adjacent to the bending portion and connected to the frame.

2. The display module according to claim 1, wherein the light source contacts the bending portion.

3. The display module according to claim 1, wherein the back plate support comprises a second lateral portion, the frame has an outer lateral surface, and the second lateral portion is adjacent to and faces the outer lateral surface of the frame.

4. The display module according to claim 1, wherein the light source comprises a first engaging portion, the frame comprises a second engaging portion, and the light source is connected to the frame through the engaging between the first engaging portion and the second engaging portion.

5. The display module according to claim 1, wherein the back plate support is made from an insulation material.

6. The display module according to claim 1, wherein the frame has an inner lateral surface, the back plate support comprises a first lateral portion, and the inner lateral surface is adjacent to and faces the first lateral portion.

7. A display device, comprising:
a display module, comprising:
a back plate support;
a display panel disposed on the back plate support;
a frame having a bending portion; and
a light source disposed adjacent to the bending portion and connected to the frame; and
a casing encapsulating a portion of the display module.

8. The display device according to claim 7, wherein the light source contacts the bending portion.

9. The display device according to claim 7, wherein the back plate support comprises a second lateral portion, the frame has an outer lateral surface, and the second lateral portion is adjacent to and faces the outer lateral surface of the frame.

10. The display device according to claim 7, wherein the light source comprises a first engaging portion, the frame comprises a second engaging portion, and the light source is connected to the frame through the engaging between the first engaging portion and the second engaging portion.

11. The display device according to claim 7, wherein the back plate support is made from an insulation material.

12. The display device according to claim 7, wherein the frame has an inner lateral surface, the back plate support comprises a first lateral portion, and the inner lateral surface is adjacent to and faces the first lateral portion.
